(19) United States
(12) Patent Application Publication
(10) Pub. No.: US 2002/0131714 A1
(43) Pub. Date: Sep. 19, 2002

(54) Guiding structure for transforming a gaussian type propagation mode profile into a widened type propagation mode profile and application to the manufacture of a wavelength multiplexer / demultiplexer

(76) Inventor: Piero Bruno, Meylan (FR)

Correspondence Address: PILLSBURY WINTHROP, LLP, P.O. BOX 10500, MCLEAN, VA, 22102, US

(21) Appl. No.: 09/848,542

(22) Filed: May 4, 2001

(30) Foreign Application Priority Data
Mar. 15, 2001 (FR) 0103526

(51) Int. Cl. G02B 6/26

(52) U.S. Cl. 385/45; 385/43; 385/28

(57) ABSTRACT

The invention proposes a guiding structure capable of transforming a lightwave with at least one central wavelength λᵢ with a Gaussian type propagation mode profile coming out of the introduction means into a widened type propagation mode profile, this structure comprising:

a first guiding part (1), and

a second part (2) comprising at least one microguide (3), with one end (5) in the form of a Y, the first and second part and the introduction means are connected to each other such that when the lightwave is introduced into either the first or the second part, it is transformed into the other part into a widened profile for the central wavelength λᵢ.

The invention is applicable to the manufacture of a large number of optical components, and particularly wavelength multiplexers and demultiplexers.

### TECHNICAL FIELD

This invention relates to a guiding structure for transforming a Gaussian type propagation mode profile into a widened type propagation mode profile.

This invention can be used with many optical components, and particularly components with integrated optics and particularly with pitch converters or spacing converters, and wavelength multiplexers/demultiplexers.

1. State of the Art

In a guiding structure in integrated optics, a lightwave propagates either in a planar guide, or in a laterally confined optical guide that we will call a microguide.

A planar guide or a microguide is composed of a central part called the core and surrounding media all around it that may all be identical or may be different.

To enable confinement of light in the central part, the refraction index of the medium making up this part must be different and generally higher than that of surrounding media.

In order to simplify the description, the planar guide and the microguide will be considered to be concentrated at their central part. Furthermore, all or part of the surrounding media will be called the substrate, although it is clearly understood that one of the surrounding media may for example be air when the microguide or the planar guide are not embedded or are only slightly embedded.

The substrate may be single-layer or multi-layer, depending on the type of technique used.

One wave propagation mode corresponds to an area in space or in a structure within which the energy of the lightwave is confined.

When a lightwave with a Gaussian type profile propagation mode Pₒ is injected into a microguide with a Gaussian profile propagation mode P_{g}, the coupling between the wave and the guide is better if the maximum values of the two Gaussian profiles are superposed.

These Gaussian profiles are defined with respect to a plane according to the xy axes perpendicular to the propagation direction z, the x axis being an axis parallel to the substrate plane of the guide.

FIG. 1a shows an example of a Gaussian type propagation profile P₀ for an incident lightwave for a wavelength λᵢ called the central wavelength, and a Gaussian type propagation profile P_{g} of a microguide for this wavelength λᵢ. These profiles illustrate the distribution of intensity I as a function of the x axis (the same types of profiles and reasoning may be applied along the y axis). The light intensity output from the incident wave and coupled in the guide, depends on the overlap integral between these two profiles; this overlap integral corresponds to the cross-hatched area in FIG. 1a. It can be seen in this figure that the maximum coupling is obtained when the two profiles are superposed, in other words when the maximum intensities of the P_{g} and Pₒ profiles are obtained for x=x_{g}=Xₒ. The coupling is worst as the absolute value of δₓ=x_{g}−xₒ increases.

FIG. 1b shows the light intensity coupled in the guide as a function of δₓ. The profile P₁ obtained is of the Gaussian type with an average width L₁ₓ (for example defined at 80% of the value I₁).

The same reasoning may be used for the y axis.

The variation δₓ and/or δₓ may be due to many factors, for example such as thermal perturbations, x and/or y positioning errors of the incident wave at the input to the guide, etc.

More specifically, variations in outside parameters such as the temperature produce variations in the central wavelength λᵢ, particularly in demultiplexing devices, by a value δ_{λ} that also results in a variation of δₓ that is usually proportional to δ_{λ}. This variation may be particularly penalizing in optical devices.

### DESCRIPTION OF THE INVENTION AND BRIEF DESCRIPTION OF THE FIGURES

In order to overcome this problem, the invention proposes an innovative guiding structure capable of giving the most stable possible overlap integral despite variations in δₓ and/or δ_{y}, such that the coupling between the incident wave and the guiding structure is as insensitive as possible to variations of δₓ and/or δ_{y} and therefore also of δ_{λ}.

Therefore, one purpose of the invention is to have a guiding structure with at least one guided mode as insensitive as possible to variations of δₓ and/or δ_{y} and capable of producing the maximum possible overlap integral to give a maximum coupling coefficient on the Pxy translation plane along the x and/or y axes.

In order to achieve this purpose, the said guided mode must have the widest possible profile on this translation plane.

Therefore, the guiding structure according to the invention must be capable of transforming a Gaussian type profile propagation mode into a widened type profile propagation mode in order to achieve an overlap integral as insensitive as possible to any variations in δₓ and/or δ_{y} in the translation plane, and the highest possible particularly to minimize injection losses.

The guiding structure of the invention is particularly useful in wavelength multiplexing/demultiplexing devices.

In order to achieve these purposes, the invention proposes a guiding structure capable of transforming a lightwave with at least one central wavelength λᵢ with a Gaussian type propagation mode profile coming out of the introduction means into a widened type propagation mode profile, this structure comprising:

first guiding part, and

second part comprising at least one microguide, with one end in the form of a Y at least in a plane parallel to a z direction in which the wave is propagated, the first and second part and the introduction means are optically connected to each other such that when the lightwave is introduced into either the first or the second part, it is transformed into the other part into a widened profile for the central wavelength λᵢ.

According to a first variant of the guiding structure of the invention, means of introducing the lightwave are provided at at least one of the ends of the first part, the other end of the said first part being optically connected to the Y end of the second part, the said widened profile then being obtained in the microguide of the second part.

According to a second variant of the guiding structure of the invention that is symmetric with the first variant, the means of introducing the lightwave are placed at at least one of the ends of the second part, the other end corresponding to the Y end is optically connected to one of the ends of the first part, the said widened profile then being obtained in the first part.

According to a first embodiment of the first part applicable to the first variant, this part is made in free space.

According to a second embodiment of the first part applicable to the first variant, this part comprises a planar guide.

According to a third embodiment of the first part applicable to the first and the second variants, the first part comprises at least one optical fibre or one optical microguide in which one of the ends is directly connected either through an intermediate optical element and/or a free space, to the Y end of a microguide in the second part.

Furthermore, the end of the microguide optically connected to the second part may also be in the form of a Y to further increase the insensitivity of the overlap integral to any variations in δₓ and/or δ_{y}.

The first guiding part may also be made by a combination of these modes.

According to a first embodiment of the second part, the Y shaped end of the microguide in the second part comprises two distinct guiding parts that join together into a single guiding part.

According to a second embodiment of the second part, the Y shaped end of the microguide of the second part is in the form of a taper. Unlike the first embodiment, the Y shaped taper of this second mode is then a single guiding part.

The various Y shapes can be used equally well with the first and the second variants of the invention.

The Y shape is advantageously defined in at least an xz plane parallel to the direction of propagation of the lightwave to minimise the sensitivity to variations of δₓ and therefore of δ_{y}. But the Y shape may also be defined in the yz plane perpendicular to the xz plane, possibly to reduce the sensitivity to variations of δ_{y}.

When the first part comprises a microguide with a Y-shaped end, this end may be in the different shapes described above for the second part.

Means of introduction of the lightwave comprise at least one light source optically connected to one of the parts.

The lightwave output from the introduction means is introduced into one of the first or second part, and may have a single central wavelength λᵢ or several central wavelengths λ₁, λ₂, . . . λᵢ, . . . λₙ.

When the invention is used to make a demultiplexer, the lightwave introduced into one of the parts has several central wavelengths λ₁, λ₂, . . . λᵢ, . . . λₙ. and the other part comprises at least n microguides Gᵢ where i is between 1 and n; each microguide Gᵢ is capable of guiding a central wavelength λᵢ, the first and second parts being optically connected such that only one central wavelength λᵢ is focused at the entrance to each microguide Gᵢ.

When the invention is used to make a multiplexer, the lightwave introduced into one of the parts is formed from several lightwaves with different central wavelengths λᵢ (for example output from n light subsources) and the other part comprises a microguide capable of guiding all central wavelengths λᵢ, the first and the second parts being optically connected such that the different central wavelengths λᵢ are focused at the input to the microguide of the said other part.

According to a variant embodiment, the guiding structure also comprises reflection means for example such as a diffraction grating or a holographic grating capable of optically connecting the first and second parts.

In a demultiplexer application, the said other part comprising at least one microguide for each wavelength to be multiplexed, the reflection means being capable of reflecting the lightwave with angles approximately proportional to wavelengths that are to be introduced into the different microguides in the said other part. In other words, each central wavelength is transmitted with a particular angle in order to distribute the different central wavelengths onto a microguide of the other part.

Therefore, the reflection means also make it possible to select wavelengths by sending them to different points within the space of a focal plane.

Reflection means may also be used at the output from the guiding structure to transmit the output lightwave to one or several means, for example a detector and/or a component. As a variant, couplers output from the guiding structure can also be used.

The output from the guiding structure corresponds to one end of the second part in the case of the first variant and to one end of the first part in the case of the second variant.

Other characteristics and advantages of the invention will appear clearer after reading the following description. This description is applicable to example embodiments given for explanatory purposes that are in no way limitative. It is also applicable to the attached drawings in which:

FIGS. 1a and 1b, already described, represent firstly the Gaussian profile of a lightwave and the Gaussian profile of a guided mode, and also the coupled intensity resulting from these two profiles,

FIGS. 2a and 2b represent firstly the Gaussian profile of a lightwave and the widened profile of a guided mode according to the invention, and also the coupled intensity resulting from these two profiles,

FIG. 3 diagrammatically shows a top view of a first example of a guiding structure according to the invention,

FIG. 4 diagrammatically shows a top view of a second example of a guiding structure according to the invention,

FIG. 5 diagrammatically shows a top view of a third example of a guiding structure according to the invention,

FIG. 6 diagrammatically shows a top view of a guiding structure according to the invention using reflection means,

FIG. 7 diagrammatically shows a top view of an example application of a guiding structure according to the invention for the manufacture of a multiplexer,

FIG. 8 diagrammatically shows a top view of an example application of a guiding structure according to the invention for the manufacture of a demultiplexer,

FIG. 9 diagrammatically shows a top view of an example symmetric variant of the previous guiding structures.

### DETAILED PRESENTATION OF EMBODIMENTS

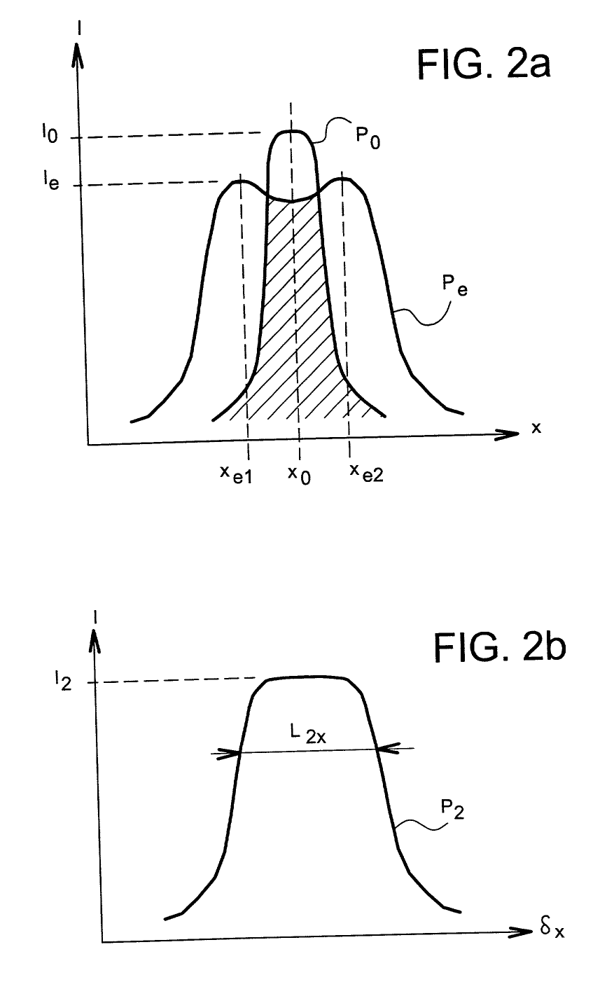

FIG. 2a represents the Gaussian profile Pₒ of a lightwave at the central wavelength λᵢ and the widened profile Pₑ of a guided mode obtained for this wavelength λᵢ by the use of a Y in a guiding structure according to the invention. These profiles represent the intensity I as a function of x.

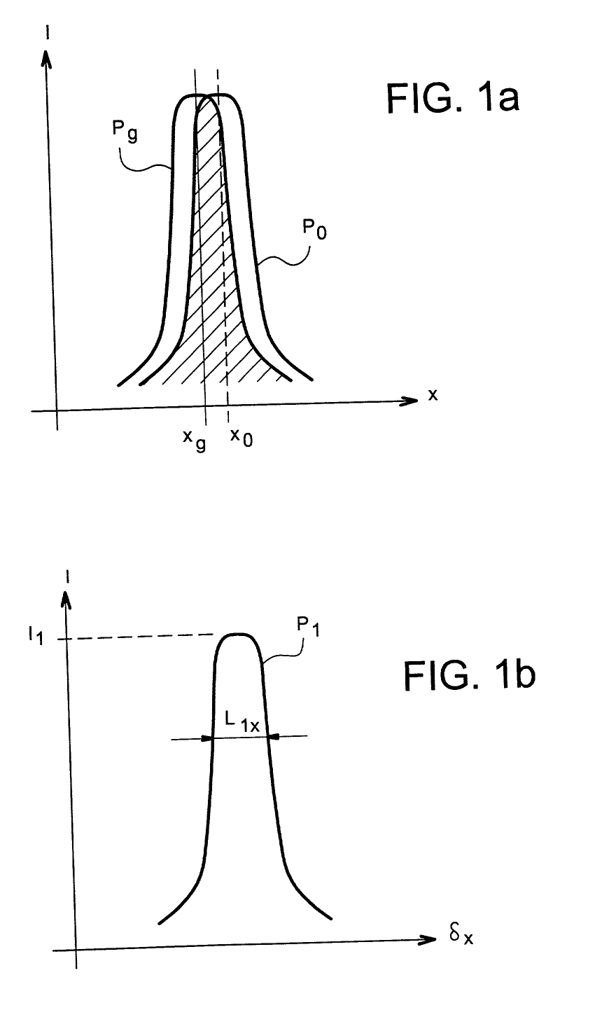

As can be seen in FIG. 1a, the maximum intensity I₀ of the profile P₀ in FIG. 2a is at x=x₀. On the other hand, the profile Pₑ may have one or several maxima depending on the type of the Y shape used. If a Y forming a single guide is used, the maximum Iₑ will be obtained for a range of x varying from xₑ₁ to Xₑ₂. If a Y formed from two distinct guide branches is used, the profile Pₑ will have two maxima, as shown in FIG. 2a for values x=xₑ₁ and x=xₑ₂. The values xₑ₁ and xₑ₂ are obviously related to the dimensions of the Y.

This figure shows that the overlap integral of profiles Pₒ and Pₑ (cross-hatched in the figure) is relatively stable even if δₓ varies taking account of the profile width Pₑ.

FIG. 2b illustrates the resulting light intensity after the wave with profile s o has passed in the guided mode profile Pₑ as a function of δₓ. This figure clearly shows that the lightwave with a Gaussian profile Pₒ was transformed into a widened profile P₂ with average width L₂ₓ (for example defined at 80% of the value I₂), where L₂ₓ is very much greater than L₁ₓ in FIG. 1b.

The same reasoning can be used along the Y axis.

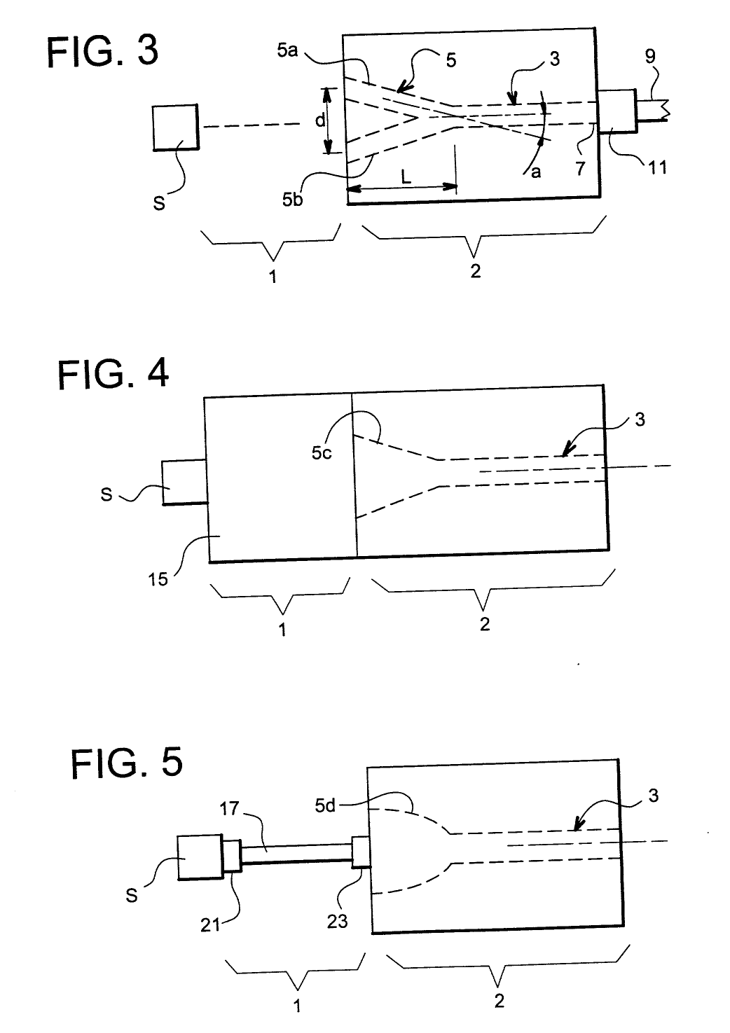

FIG. 3 diagrammatically illustrates a top view of a first example guiding structure according to the invention associated with a light source S capable of emitting a lightwave with at least one Gaussian profile for a central wavelength λᵢ.

This guiding structure comprises a first part 1 facing this source S, formed in this example by a free space that can enable the propagation of the lightwave at least for the central wavelength λᵢ according to a Gaussian type propagation profile. This structure also comprises a second part 2, comprising at least one microguide 3, advantageously single-mode, for which one end 5 is in the shape of a Y facing the first part; this microguide is designed to receive the wave with the Gaussian profile at the central wavelength λᵢ originating from the first part, and transforming it into a wave with a widened propagation profile (see FIG. 2b) with a central wavelength λᵢ.

The other end 7 of the microguide 3, which corresponds to the output from the guiding structure, is optically connected by any known connecting means to another component and/or processing means, for example such as a detector.

Some examples of these connecting means are an optical fibre 9 connected to the output 7 from the microguide 3 through an appropriate ferrule 11, or a free space possibly with reflection means or glue designed to hold a component in place, possibly comprising for example a coupler.

In this example embodiment, the Y shaped end 5 of the microguide comprises two distinct guiding parts 5a and 5b, the optical axes of which are separated by a maximum distance d joining together into a single guiding part.

For example, for a guiding structure made using the ion exchange technique in glass, the microguide 3 has a mode diameter equal to 10.2 μm at 1/e², a value d varying from 2 to 20 μm, an end Y with a length L along the z axis varying from 100 to 5000 μm and an angle a varying from 0.01° to 1°, this angle a corresponding to the inclination of the branches of the Y from the z axis.

FIG. 4 diagrammatically shows a top view of a second example of the guiding structure according to the invention.

In this example, the first part of the structure is a planar guide 15 placed between the source S and the second part of the structure. This planar guide is capable of enabling propagation of the lightwave along an xz plane parallel to the plane in the figure and containing the wave propagation direction. This first part is put into contact with the second part, for example by gluing, or is made from the same substrate as the second part.

Furthermore in this variant, the Y shaped end 5c of the microguide that is advantageously single-mode 3 describes a taper in the same parallel xz plane. This taper forms a single guide part facing the first part.

Finally, as an example, this FIG. 1A shows the source S optically connected directly to the first part of the structure, for example by gluing (it could also be connected indirectly for example by a ferrule).

FIG. 5 diagrammatically shows a top view of a third example of a guiding structure according to the invention. In this example, the first part of the structure is an optical fibre 17 (an optical microguide made in a substrate inserted between the source and the part 2 could also have been used instead of a fibre). This fibre provides an optical connection from the source to the second part of the guiding structure; in this example, the fibre is mechanically connected to the source by a ferrule 21, and to the second part of the guiding structure by another ferrule 23.

This fibre can enable propagation of the lightwave according to a Gaussian type profile.

Furthermore, in this variant, the Y shaped end 5d of the microguide 3 that is advantageously in single mode is in the shape of a taper (at least in the xz plane parallel to the plane in the figure and containing the direction of propagation), that is more rounded than the end 5c in FIG. 4.

Obviously, there are many variant embodiments of the first and second parts of the structure according to the invention. Furthermore, the structure according to the invention can also be made by a combination of these variants.

In order to simplify the rest of the description, the Y shaped end shown in FIG. 4 will be used as an example. Furthermore, in order to introduce the lightwave in the first part or the second part, the structure according to the invention comprises wave introduction means as described above. In all examples shown, these means are formed from a light source S optically connected to the first part or the second part, possibly through free space.

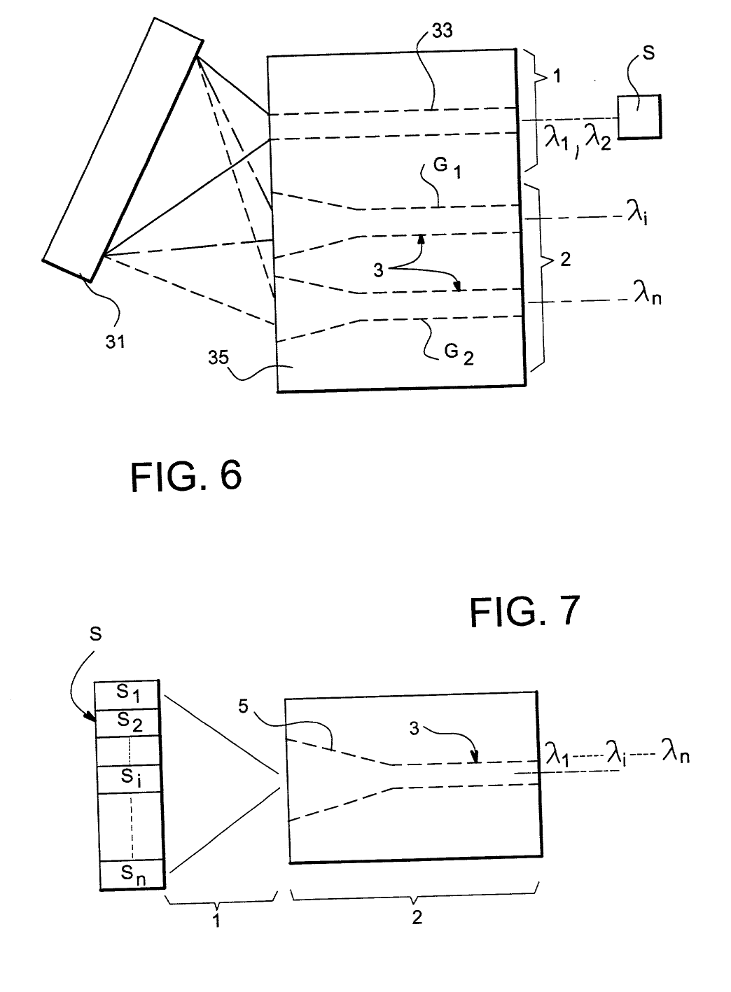

FIG. 6 diagrammatically shows a top view of a guiding structure using reflection means. In this structure, the first part 1 and the second part 2 are made from the same substrate 35. The first part comprises a microguide 33, one end of which is facing a light source and the other end is facing the reflection means 31. The second part comprises at least one microguide 3, the Y shaped end of which is facing reflection means while the other end forms the output from the guiding structure. Reflection means 31 are capable of reflecting the lightwave output from the microguide 33 in the first part 1 with an angle proportional to the wavelength that is to be input into the microguide(s) 3 in the second part.

For example, these reflection means are made by a diffraction grating or a holographic grating. In particular, the use of reflection means enables a more compact guiding structure since the source is not necessarily placed facing the first or second part of the guiding structure (unlike the previous figures) In this example, the source is laid out on the same side of the guiding structure as the output from the said guiding structure.

As an example, this figure shows a lightwave output from the source with two central wavelengths λ₁ and λ₂, the reflection means reflecting the lightwave output from microguide 33 with a particular angle for each of the wavelengths so that the central wavelength λ₁ can thus be distributed on a microguide G₁ of the second part, and the central wavelength λ₂ can be distributed on a microguide G₂ of the second part, distinct from G₁.

Therefore, the reflection means can also be used to select wavelengths by sending them to different points within the space of a focal plane located at the entry to the second part. These reflection means can thus be used to make a wavelength demultiplexer.

Obviously, reflection means may also be used at the output from the second part to transmit the output lightwave to other means, for example a detector and/or another component.

FIG. 7 diagrammatically shows another top view of an example application of the structure of the invention for the production of a multiplexer.

In this example, the light source is equivalent to a set of light sources S₁, S₂, . . . Sᵢ, . . . Sₙ, emitting at central wavelengths λ₁, λ₂, . . . λᵢ, . . . λₙ respectively that are focused through the first part in this case formed by a free space at the entry to an end 5 of a microguide 3 in the second part. This microguide 3 is such that the Gaussian type propagation profiles with central wavelengths λᵢ entering into the Y shaped end of microguide 3 are output from the microguide in a single wave with wider profiles for these wavelengths.

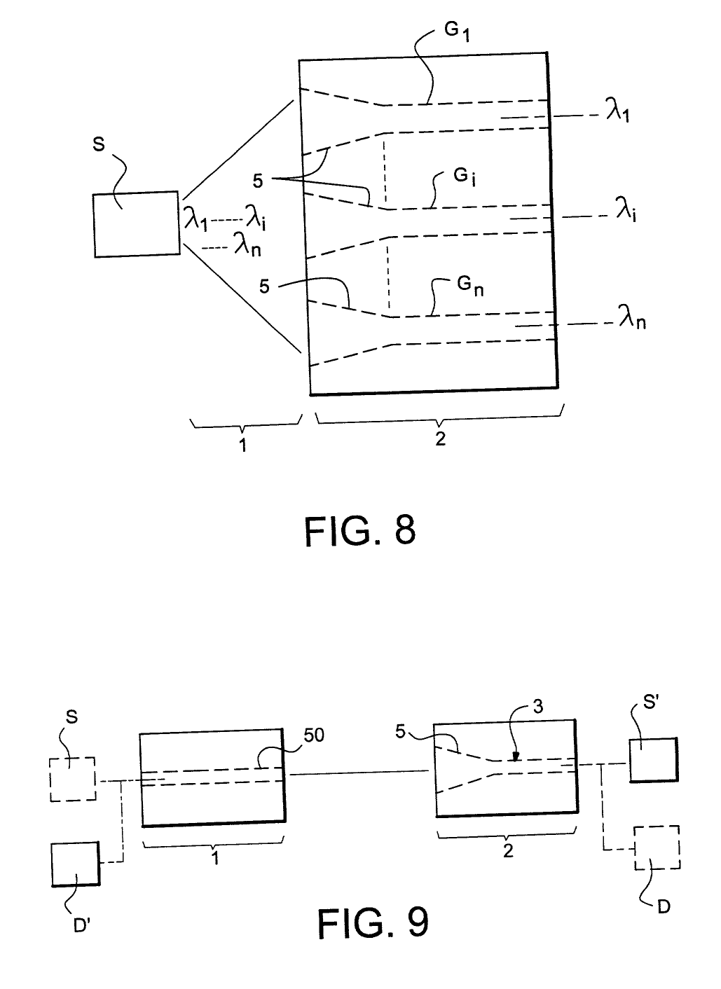

FIG. 8 diagrammatically shows a top view of another example application of the structure according to the invention for making a demultiplexer.

In this example, the light source S emits a wave with central wavelengths λ₁, λ₂, . . . λᵢ, . . . λₙ through the first part, in this case formed by a free space, towards the ends 5 of n microguides 3 of the second part reference G₁, . . . Gᵢ, . . . Gₙ. These microguides are arranged in the second part of the structure such that only one central wavelength λᵢ is focused at the input to a single microguide Gᵢ. Thus, each wavelength λᵢ entering a microguide Gᵢ along a Gaussian type propagation profile is transformed in the second part along a wider propagation profile.

In all the previous examples, the lightwave enters into the first part and comes out of the guiding structure through the second part. However, symmetric embodiments may be made by introducing the lightwave in the second part and recovering it at the output from the first part.

FIG. 9 diagrammatically shows a top view of an example symmetric variant of the previous guiding structures.

In this variant, the source S′ emits a lightwave in a microguide 3 of the second part, from an end opposite to the Y shaped end. The Y shaped end is optically connected to a microguide 50 in the first part either directly (in other words the first and second parts are in contact) or through an intermediate element that may be a free space as shown in this figure.

This type of symmetric variant can give a wider profile wave starting from a wave with a Gaussian profile.

It will also be possible to envisage structures capable of working in both directions. Thus, another source S located at the other end of the guiding structure is shown in dotted lines. For example, couplers placed between sources and the guiding structure are used to sample part of the lightwave, for example to transmit it to detectors D, D′, so that the lightwave can be recovered at one of the ends of the guiding structure despite the presence of sources S and S′.

The guiding structure according to the invention may be manufactured by any techniques used to manufacture integrated optics components and particularly by manufacturing techniques for integrated optics by ionic exchange in glass, or by flame hydrolysis deposition (FHD), or Plasma Enhanced Chemical Vapour Deposition (PECVD), on silica, silicon or on polymers.

Furthermore, Y shapes in all these figures are shown in the xz plane, but as we have already mentioned the Y shape may also be made on the yz plane or on the xz or yz planes to form a Y in three dimensions.

1. Guiding structure capable of transforming a lightwave with at least one central wavelength λᵢ with a Gaussian type propagation mode profile coming out of the introduction means (S, S′) into a widened type propagation mode profile, this structure comprising:
a first guiding part (1), and
a second part (2) comprising at least one microguide, with one end (5) in the form of a Y, the first and second part and the introduction means are optically connected to each other such that when the lightwave is introduced into either the first or the second part, it is transformed into the other part into a widened profile for the central wavelength λᵢ.

2. Guiding structure according to claim 1, characterized in that the means (S) of introducing the lightwave are provided at at least one of the ends of the first part, the other end of the said first part being optically connected to the Y end of the second part, the said widened profile then being obtained in the second part.

3. Guiding structure according to claim 1, characterized in that the means (S′) of introducing the lightwave are placed at at least one of the ends of the second part, the other end corresponding to the Y shaped end is optically connected to one of the ends of the first part, the said widened profile then being obtained in the first part.

4. Guiding structure according to claim 2, characterized in that the first part consists of free space.

5. Guiding structure according to claim 2, characterized in that the first part comprises a planar guide.

6. Guiding structure according to either of claims 2 or 3, characterized in that the first part comprises at least one optical fibre, with at least one of its ends being optically connected to the Y shaped end of a microguide in the second part.

7. Guiding structure according to either of claims 2 or 3, characterized in that the first part comprises at least one optical microguide, with at least one of its ends being optically connected to the Y shaped end of a microguide in the second part.

8. Guiding structure according to claim 7, characterized in that the end of the microguide optically connected to the second part is in the form of a Y.

9. Guiding structure according to any one of claims 1 or 8, characterized in that the Y shaped end comprises two distinct guiding parts that join together into a single guiding part.

10. Guiding structure according to any one of claims 1 or 8, characterized in that the Y shaped end forms a taper.

11. Guiding structure according to claim 1, characterized in that the means of introducing the lightwave comprise at least one light source optically connected to one of the parts.

12. Guiding structure according to claim 1, characterized in that the first part and the second part are optically connected to each other through reflection means.

13. Guiding structure according to claim 12, characterized in that the reflection means are chosen to be a diffraction grating or a holographic grating.

14. Guiding structure according to any one of claims 1 or 13 used to make a demultiplexer, characterized in that the means of introduction emit a lightwave in one of the parts at several different central wavelengths λ₁, λ₂, . . . λᵢ, . . . λₙ and that the other part comprises at least n microguides Gᵢ where i is between 1 and n; each microguide Gᵢ being capable of guiding a central wavelength λᵢ, the first and the second parts being optically connected such that only a single central wavelength λᵢ is focused at the input to each microguide Gᵢ.

15. Guiding structure according to claim 14, characterized in that the first and second parts are connected together through reflection means reflecting each central wavelength λᵢ at a particular angle, so that a single central wavelength λᵢ can be focussed at the input to a single microguide Gᵢ.

16. Guiding structure according to any one of claims 1 to 13 used to make a multiplexer, characterized in that the introduction means emit a lightwave into one of the parts formed from several lightwaves with different central wavelengths λᵢ, and in that the other part comprises a microguide capable of guiding all central wavelengths λᵢ, the first and the second parts being optically connected such that the different central wavelengths λᵢ are focused at the input to the microguide of the said other part.
